(19) United States
(12) Patent Application Publication
(10) Pub. No.: US 2024/0375111 A1
(43) Pub. Date: Nov. 14, 2024

(54) PCR DEVICE

(71) Applicant: UNIVERSAL BIO RESEARCH CO., LTD., Matsudo-shi, Chiba (JP)

(72) Inventor: Hideji TAJIMA, Matsudo-shi, Chiba (JP)

(21) Appl. No.: 18/688,203

(22) PCT Filed: Aug. 29, 2022
(86) PCT No.: PCT/JP2022/032305

§ 371 Date: Feb. 29, 2024

(30) Foreign Application Priority Data
Sep. 1, 2021 (JP) 2021-142390

(51) Int. Cl. B01L 7/00

(52) U.S. Cl. CPC B01L 7/52; B01L 2300/1822; B01L 2300/1894

(57) ABSTRACT

A PCR device includes: a vessel configured to house a reaction solution to be subjected to PCR; a heater-cooler configured to heat and cool the reaction solution in the vessel; a cap configured to seal the vessel; and a detection end portion configured to be movable relative to the vessel, in a state of being mounted with the cap.

### TECHNICAL FIELD

The present invention relates to a PCR device that performs PCR and measures amplified nucleic acids.

### BACKGROUND ART

To detect a pathogen such as a virus, a polymerase chain reaction (PCR) method using PCR that has become popular with development of genetic engineering is used. A specimen including a pathogen is collected using a commercially-available collection kit, nucleic acids (DNAs or RNAs) are extracted from the specimen, the nucleic acids are amplified by the PCR method, and the pathogen is tested based on the amplified nucleic acids.

The PCR method is mainly performed by hand. However, when the PCR method is performed by hand, it is difficult to continuously perform a large amount of testing steps, and erroneous operation and contamination may occur during the testing steps. Therefore, an automatic PCR testing device that automatically performs the PCR method has been proposed. For example, as the automatic PCR testing device, a fully automatic PCR testing system (geneLEAD series) available from Precision System Science Co., Ltd. can be used. The fully automatic PCR testing system can extract a specimen from a specimen vessel housing the specimen without human intervention, and perform a PCR test.

During the PCR test, a PCR cycle is repeatedly performed a few dozen times by using a reaction solution containing the amplified nucleic acids and a reagent. One PCR cycle includes heating of the reaction solution to a predetermined temperature and keeping of the temperature for a predetermined time, and cooling of the reaction solution to a predetermined temperature and keeping of the temperature for a predetermined time. To repeat the PCR cycle a few dozen times, a relatively long time is necessary until amplification of the nucleic acids is completed. Therefore, to reduce the time of the PCR cycle, an amount of reaction solution may be reduced, and a time for cooling and heating the reaction solution to the predetermined temperature may be reduced. Although a relatively large amount of reaction solution (for example, several tens of μl) is used in normal PCR, the amount of reaction solution may be reduced, and the PCR may be performed using a relatively small amount of reaction solution (for example, 3 μl to 10 μl).

Patent Literature 1 proposed by the inventor of the present application discloses a reaction device that performs the PCR while a vessel 1 is sealed with a cover member 3. Protruding parts of the cover member 3 are housed in a reaction chamber 21 of the vessel 1 to reduce a volume of the reaction chamber, and the PCR is performed using a relatively small amount of reaction solution. Patent Literature 2 also discloses a similar PCR device.

In contrast, in real-time PCR, the nucleic acids can be quantitated by measuring fluorescence intensity of a fluorescent substance combined with the nucleic acids contained in the reaction solution during the PCR cycle. In the real-time PCR, it is necessary to provide a detection end portion that irradiates the reaction solution with excitation light and receives fluorescence from the reaction solution, on a periphery of the vessel. Non Patent Literature 1 describes a technique for measuring nucleic acids by using a detection end portion disposed above the vessel subjected to the PCR. In such arrangement, dew condensation of water vapor generated in heating of the reaction solution occurs on a surface of the detection end portion, which may cause incorrect detection of a state of the nucleic acids and the like in the reaction solution. Therefore, in Non Patent Literature 1, arrangement of a hot collar for preventing dew condensation on a periphery of the detection end portion is illustrated.

### CITATION LIST

### Patent Literature

Patent Literature 1: Japanese Patent Laid-Open No. 2002-10777

Patent Literature 2: Great Britain Patent Application Publication No. 2333250

### Non Patent Literature

Non Patent Literature 1: L x L Scanner, Precision System Science Co., Ltd., [online], [searched on Aug. 31, 2021], Internet <URL: http://www.pss.co.jp/technology/measurement/llscanner.html>

### SUMMARY OF INVENTION

### Technical Problem

When the PCR is performed, the vessel may be sealed with a cap in order to avoid evaporation of the reaction solution. At this time, arrangement of the detection end portion relative to the vessel sealed with the cap becomes an issue.

Therefore, the present invention provides a PCR device that can detect a state of a reaction solution in a vessel sealed with a cap, by a detection end portion.

### Solution to Problem

Each aspect of the present invention is configured as follows.

### [Aspect 1]

A PCR device including:
a vessel configured to house a reaction solution to be subjected to PCR;
a heater-cooler configured to heat and cool the reaction solution in the vessel;
a cap configured to seal the vessel; and
a detection end portion configured to detect a state of the reaction solution through the cap.

### [Aspect 2]

The PCR device according to aspect 1, in which
the vessel includes a vessel upper portion and a vessel lower portion protruding downward from the vessel upper portion, and the vessel lower portion is made smaller in diameter than the vessel upper portion,
the cap includes a cap upper portion and a cap lower portion protruding downward from the cap upper portion, and the cap lower portion is made smaller in diameter than the cap upper portion, and
in a state where the cap is mounted on the vessel, the cap upper portion is housed in the vessel upper portion, and the cap lower portion is housed in the vessel lower portion.

### [Aspect 3]

The PCR device according to aspect 2, in which the vessel upper portion includes a vessel upper protrusion on an inner surface, the cap upper portion includes a cap protrusion on an outer surface, and the cap is held to the vessel by engagement of the vessel upper protrusion and the cap protrusion.

### [Aspect 4]

The PCR device according to aspect 2 or 3, further including an elastic seal configured to seal a gap between the vessel upper portion and the cap upper portion.

### [Aspect 5]

The PCR device according to aspect 4, in which the vessel upper portion includes a vessel lower protrusion on an inner surface, and the elastic seal is held to the vessel by engagement of the vessel lower protrusion and the elastic seal.

### [Aspect 6]

The PCR device according to any one of aspects 2 to 5, in which, in the state where the cap is mounted on the vessel, a lower end of the detection end portion faces a light transmitting part provided on the cap lower portion.

### [Aspect 7]

The PCR device according to aspect 6, in which the light transmitting part faces a vessel lowermost part of the vessel lower portion.

### [Aspect 8]

The PCR device according to aspect 7, in which the vessel houses 3 μl to 10 μl of the reaction solution between the light transmitting part and the vessel lowermost part.

### [Aspect 9]

The PCR device according to any one of aspects 1 to 8, in which the detection end portion includes an optical component, an end-portion housing configured to house a part of the optical component, and an end-portion protrusion protruding downward from the end-portion housing and configured to house a lower end part of the optical component.

### [Aspect 10]

The PCR device according to any one of aspects 2 to 8, in which
the detection end portion includes an optical component, an end-portion housing configured to house a part of the optical component, and an end-portion protrusion protruding downward from the end-portion housing and configured to house a lower end part of the optical component, and
a lower part of the end-portion housing is housed in the cap upper portion, and the end-portion protrusion is housed in the cap lower portion.

### [Aspect 11]

The PCR device according to aspect 9 or 10, in which the optical component at least includes an optical fiber and a light guide provided at a lower end of the optical fiber.

### [Aspect 12]

The PCR device according to aspect 11, in which the light guide faces a light transmitting part provided on the cap lower portion.

### [Aspect 13]

The PCR device according to any one of aspects 1 to 12, further including a detection end portion moving mechanism configured to move the detection end portion in a horizontal direction and a perpendicular direction.

### [Aspect 14]

The PCR device according to aspect 13, in which the detection end portion is mounted with the cap.

### [Aspect 15]

The PCR device according to any one of aspects 2 to 14, in which the heater-cooler includes a concave part configured to receive a part of the vessel lower portion.

### [Aspect 16]

The PCR device according to aspect 15, in which the heater-cooler includes a heat conductive block including the concave part, a Peltier element provided under the heat conductive block, and a heat exchange heatsink provided under the Peltier element.

### [Aspect 17]

The PCR device according to aspect 16, in which the heat conductive block includes a block protrusion protruding upward in a tapered shape, and the concave part is provided at an upper end of the block protrusion.

### [Aspect 18]

The PCR device according to any one of aspects 1 to 17, further including a heater configured to heat the vessel or the vessel lower portion.

### Advantageous Effects of Invention

The PCR device according to the present invention can detect the state of the reaction solution in the vessel sealed with the cap, by the detection end portion through the cap.

### BRIEF DESCRIPTION OF DRAWINGS

FIG. 1 is an exploded perspective view illustrating a PCR device according to an embodiment of the present invention.

FIG. 2 is an exploded perspective view illustrating a vessel in FIG. 1.

FIG. 3 is a cross-sectional side view illustrating the vessel in FIG. 1.

FIGS. 4(a) and 4(b) are perspective views illustrating a cap in FIG. 1.

FIG. 5 is a cross-sectional side view illustrating a state where the cap is mounted on a detection end portion in FIG. 1.

FIGS. 6(a) and 6(b) are cross sectional side views of the PCR device illustrating a state where the vessel is sealed with the cap.

FIGS. 7(a), 7(b), 7(c) are cross sectional side views illustrating the vessel and the cap in FIGS. 6(a) and 6(b).

### DESCRIPTION OF EMBODIMENT

An embodiment according to a PCR device of the present invention is described with reference to drawings. In the drawings, the same components are denoted by the same reference numerals, and description thereof is appropriately omitted. The PCR device according to the present embodiment is described as an PCR device performing real-time PCR; however, the present invention is not limited to the real-time PCR, and the PCR device can measure a state of a reaction solution in a vessel.

### [Entire Configuration of PCR Device]

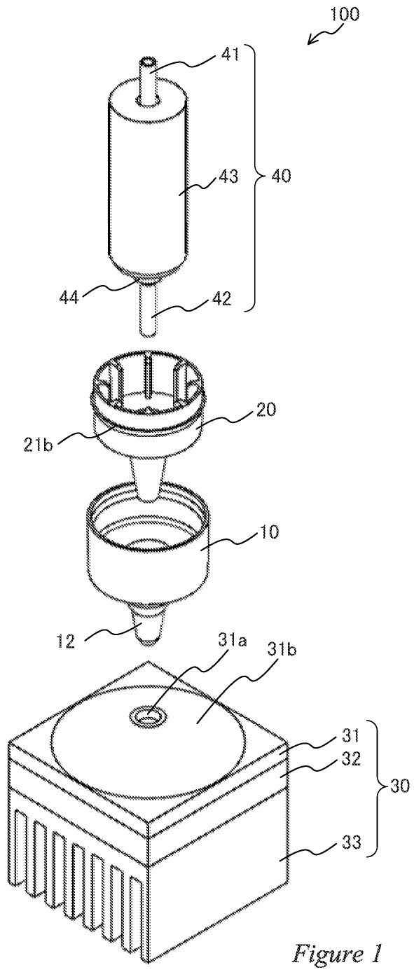

The PCR device according to the embodiment of the present invention is described with reference to FIG. 1. As illustrated in FIG. 1, a PCR device 100 includes a vessel 10 that houses a reaction solution containing a PCR reagent and a specimen such as nucleic acids, a cap 20 sealing an opening of the vessel 10, a heater-cooler 30 heating and cooling the reaction solution in the vessel 10, and a detection end portion 40 detecting a state of the reaction solution in the vessel 10 sealed with the cap 20.

### [Vessel]

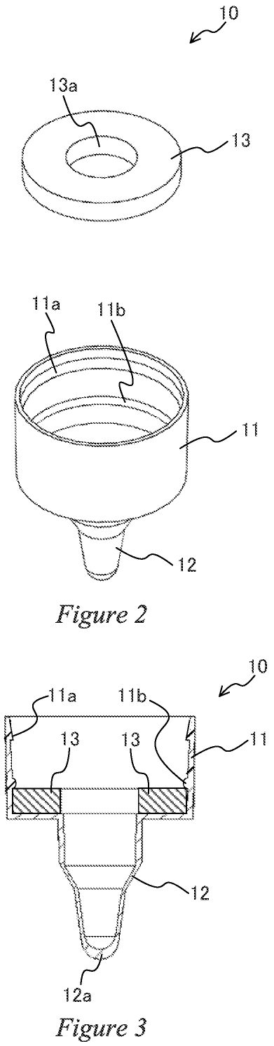

A structure of the vessel 10 is described with reference to FIGS. 2 and 3. The vessel 10 includes a vessel upper portion 11 housing a cap upper portion 21 of the cap 20, a vessel lower portion 12 housing a cap lower portion 22 of the cap 20 and the reaction solution, and an elastic seal 13 disposed on an inner bottom surface of the vessel upper portion 11. The vessel upper portion 11 preferably has a bottomed cylindrical shape. The vessel lower portion 12 is made smaller in diameter than the vessel upper portion 11.

The vessel 10 includes one or a plurality of vessel upper protrusions 11a provided on an upper side on an inner peripheral surface of the vessel upper portion 11, and one or a plurality of vessel lower protrusions 11b provided on a lower side on the inner peripheral surface of the vessel upper portion 11. The vessel upper protrusions 11a and/or the vessel lower protrusions 11b are preferably provided to protrude in a ring shape on the inner peripheral surface of the vessel upper portion 11.

The vessel lower portion 12 preferably protrudes downward from a bottom center of the vessel upper portion 11. The vessel lower portion 12 includes a vessel lowermost part 12a formed in a round shape. The elastic seal 13 is a disk having an opening at a center, and is made of a liquid-tight elastic material (for example, silicone rubber). When the vessel lower protrusions 11b and the elastic seal 13 engage with each other, the elastic seal 13 is held to the vessel 10. More specifically, when the elastic seal 13 is disposed on the bottom surface of the vessel upper portion 11, an upper outer peripheral part of the elastic seal 13 is pressed by cap lower protrusions 21b. As a result, the elastic seal 13 is held to the vessel 10.

### [Cap]

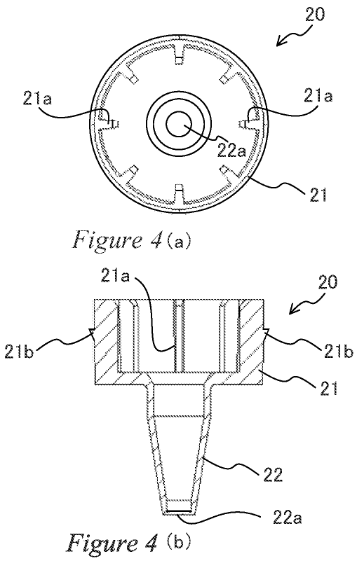

A structure of the cap 20 is described with reference to FIGS. 4(a) and 4(b). The cap 20 includes the cap upper portion 21 housing at least a part of an end-portion housing 43 of the detection end portion 40, and a cap lower portion 22 housing a light guide 42 of the detection end portion 40. The cap lower portion 22 protrudes downward from a bottom center of the cap upper portion 21. The cap lower portion 22 is made smaller in diameter than the cap upper portion 21.

The cap upper portion 21 includes one or a plurality of cap protrusions 21b provided on an outer peripheral surface of the cap upper portion 21. The cap protrusions 21b are preferably provided to protrude in a ring shape on the outer peripheral surface of the cap upper portion 21. The cap upper portion 21 preferably includes a plurality of ribs 21a provided on the inner peripheral surface of the cap upper portion 21. The cap lower portion 22 includes a flat light transmitting part 22a at a lower end. The cap lower portion 22 is preferably formed in a tapered shape. In the cap lower portion 22, at least the light transmitting part 22a is made of a transparent material. As the transparent material, a resin allowing excitation light and fluorescence described below to pass therethrough can be used.

### [Detection End Portion]

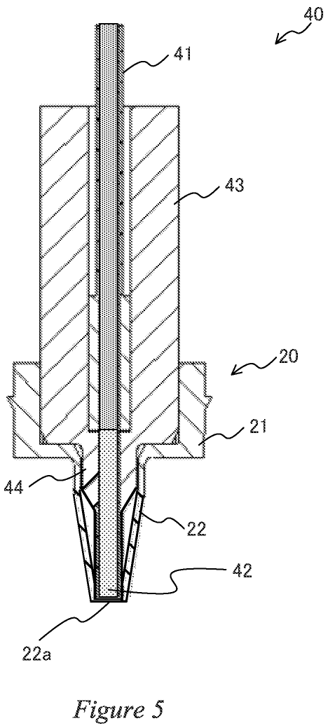

A structure of the detection end portion 40 is described with reference to FIG. 5. The detection end portion 40 is disposed so as to be movable in a horizontal direction and a perpendicular direction, above a vessel supporter 50 described below. An unillustrated detection end portion moving mechanism moves the detection end portion 40 in the horizontal direction and the perpendicular direction. The cap 20 can be mounted on the detection end portion 40. In a state where the cap 20 is mounted on the detection end portion 40, the detection end portion 40 can be moved by the detection end portion moving mechanism. The detection end portion 40 includes the end-portion housing 43, optical components 41 and 42, the end-portion housing 43 housing at least parts of the optical components 41 and 42, and an end-portion protrusion 44 protruding downward from the end-portion housing 43 and housing a lower end part of the optical component 42. The end-portion protrusion 44 is preferably formed in a tapered shape.

The optical components include an optical fiber 41 and the light guide 42. The optical components may include the optical fiber 41, the light guide 42, and a lens disposed at a lower end of the light guide 42. The end-portion housing 43 preferably has a cylindrical shape, and internally houses at least a part (first terminal part) of the optical fiber 41. The end-portion protrusion 44 preferably protrudes downward in a tapered shape. The end-portion protrusion 44 holds the light guide 42. A lower part of the end-portion housing 43 is housed in the cap upper portion 21, and the end-portion protrusion 44 is housed in the cap lower portion 22.

The optical fiber 41 preferably includes an excitation light irradiation optical fiber and a fluorescence detection optical fiber. A second terminal part of the optical fiber 41 is connected to an unillustrated detection main body (for example, excitation light source and light receiving element). A lower end part of the optical fiber 41 is connected to the light guide 42. The lower end part of the light guide 42 extends to a vicinity of an inner surface of the light transmitting part 22a. The lower end part (lower end surface) of the light guide 42 faces the inner surface of the light transmitting part 22a. At least an upper part of the light guide 42 is preferably held by the end-portion housing 43. The cap 20 is liquid-tightly mounted on the detection end portion 40.

### [Heater-Cooler]

A structure of the heater-cooler 30 is described with reference to FIG. 1. The heater-cooler 30 includes a heat conductive block 31 heating and cooling the reaction solution in the vessel 10, a Peltier element 32 provided under the heat conductive block 31, and a heat exchange heatsink 33 provided under the Peltier element 32. The heat conductive block 31 includes a block protrusion 31b protruding upward in a tapered shape. The block protrusion 31b is preferably formed in a mountain shape. The block protrusion 31b includes a concave part or recess 31a at an upper end. The concave part 31a receives at least a part of the vessel lower portion 12. An outer surface shape of the vessel lowermost part 12a is preferably coincident with an inner surface shape of the concave part 31a such that the vessel lowermost part 12a and the concave part 31a come into tight contact with each other.

### [Arrangement of PCR Device in Use]

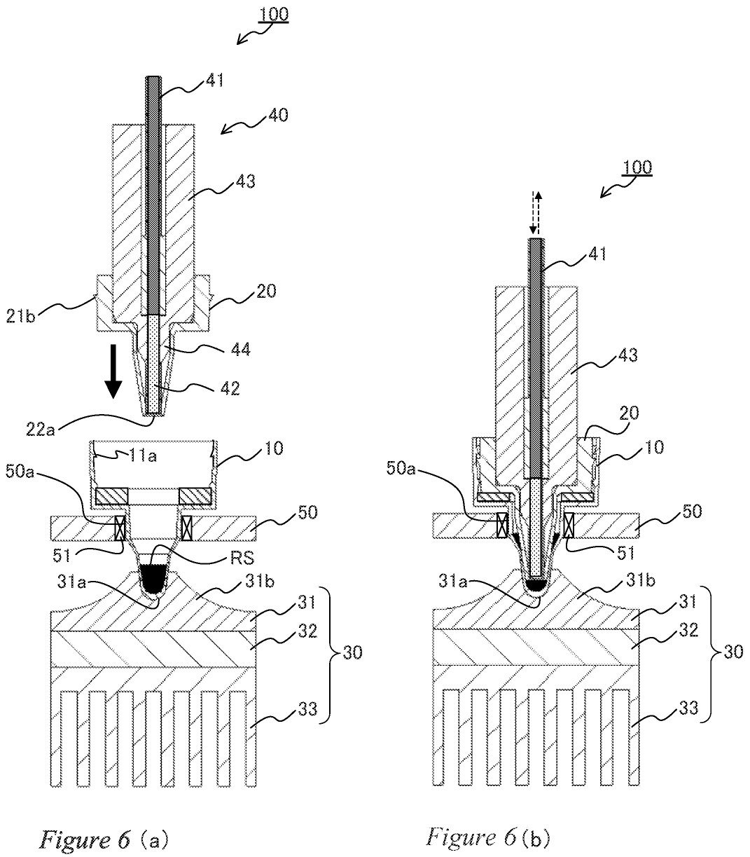

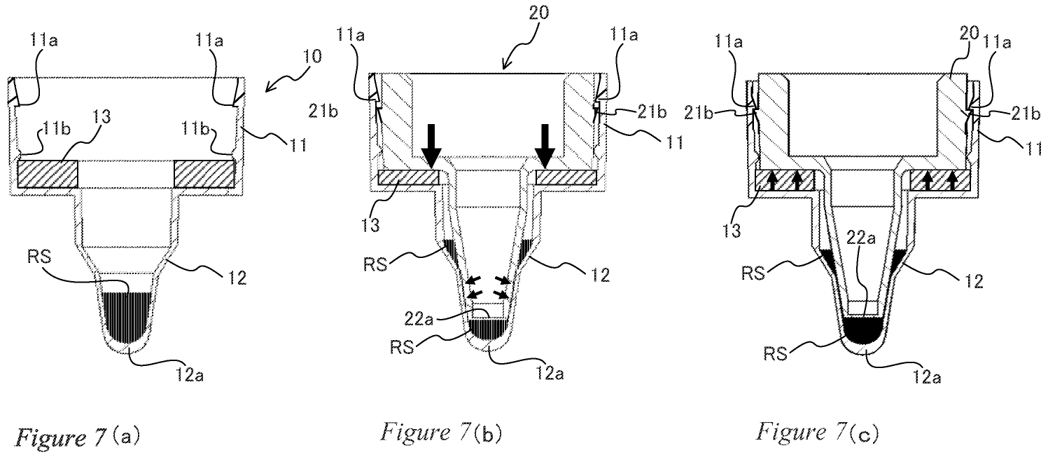

Arrangement of the PCR device 100 in use (during execution of PCR) is described with reference to FIGS. 6(a), 6(b), 7(a), 7(b) and 7(c). As illustrated in FIGS. 6(a) and 6(b), before start of the PCR, the vessel 10 is housed in an opening 50a of the vessel supporter 50. A heater 51 heating the vessel 10 or the vessel lower portion 12 may be optionally provided around the opening 50a (so as to surround the opening). The heater-cooler 30 is disposed below the vessel supporter 50. A reaction solution RS is previously dispensed into the vessel 10 by a dispensing burette (not illustrated). The dispensing burette can be moved in the horizontal direction and the perpendicular direction by a dispensing burette moving mechanism. The reaction solution RS (various kinds of reagents, buffer, etc.) and a specimen (nucleic acids before amplification) are previously dispensed from the dispensing burette into the vessel 10.

As illustrated in FIG. 6(a), in a state where the cap 20 is mounted on the detection end portion 40, the detection end portion is lowered from above the vessel 10. As illustrated in FIG. 6(b) and FIG. 7(c), the cap protrusions 21b and the vessel upper protrusions 11a engage with each other. By the engagement, the cap 20 and the vessel 10 are integrated, and the cap 20 seals the vessel 10.

In a state in FIG. 6(b), the light transmitting part 22a of the cap lower portion 22 and the lower end surface of the light guide 42 are disposed below a surface of the reaction solution RS. The light transmitting part 22a is in direct contact with the reaction solution without intermediary of air. Therefore, dew condensation does not occur on the light transmitting part 22a, and detection sensitivity is not lowered. The reaction solution RS and the air overflowing due to movement of the light transmitting surface 22a into the reaction solution RS are pushed out to a gap formed between an inner surface of the vessel lower portion 12 and an outer surface of the cap lower portion 22.

Processing for sealing the vessel 10 by the cap 20 is described with reference to FIGS. 7(a), 7(b) and 7(c). Note that, in FIGS. 7(a), 7(b) and 7(c), illustration of the heater-cooler 30, the detection end portion 40, and the vessel supporter 50 is omitted. FIG. 7(a) illustrates a state immediately before the cap 20 is mounted on the vessel 10. In the state in FIG. 7(a), the reaction solution RS is previously dispensed into the vessel lower portion 12 by the dispensing burette, and the elastic seal 13 is held in the vessel upper portion 11 by the vessel lower protrusions 11b in the vessel upper portion 11.

As illustrated in FIG. 7(b), when the cap 20 is inserted into the vessel 10 from above the vessel 10, compression force is applied to the elastic seal 13 in a vertical direction as illustrated by arrows, and the elastic seal 13 is compressed. The compression force is applied to the elastic seal 13 through the vessel 10 by downward movement of the detection end portion 40 mounted with the cap 20. Further, in the state in FIG. 7(b), force pressing an inclined peripheral surface of the cap lower portion 22 is applied to an inclined peripheral surface of the vessel lower portion 12 as illustrated by oblique arrows in FIG. 7(b), and the vessel lower portion 12 and the cap lower portion 22 are sealed together or come into tight contact with each other.

When a part of the compression force is relaxed by upward movement of the detection end portion 40, the elastic seal 13 expands in the vertical direction, and the cap 20 moves upward relative to the vessel 10 as illustrated in FIG. 7(c). Along with the movement, the vessel upper protrusions 11a and the cap protrusions 21b engage with each other, and the cap 20 is locked to the vessel 10. FIG. 7(c) illustrates the state same as in FIG. 6(b).

In the state in FIG. 6(b) and FIG. 7(c), a control unit (processor) of the PCR device operates the Peltier element 32 based on a predetermined condition, and heats and cools the reaction solution RS in the vessel 10 through the heat conductive block 31, thereby performing PCR cycle a plurality of times.

In the state in FIG. 6(b) and FIG. 7(c), in the PCR device 100, the light transmitting part 22a of the cap 20 is moved to below the surface of the reaction solution. The reaction solution RS and the air are expelled upward from the vessel lowermost part 12a by such movement. Therefore, dew condensation does not occur on the light transmitting part 22a, and detection sensitivity of the detection end portion 40 is improved.

In the state in FIG. 6(a) and FIG. 7(a), a relatively large amount of reaction solution can be dispensed into the vessel lower portion 12 by the dispensing burette. The relatively large amount of reaction solution is preferably several tens of μl, and more preferably 20±2 μl. In the state in FIG. 6(b), a relatively small amount of reaction solution can remain between the light transmitting part 22a and the vessel lowermost part 12a. The relatively small amount of reaction solution is preferably 3 μl to 10 μl, and more preferably 5±1 μl.

In the present embodiment, the PCR may be the real-time PCR. During execution of the PCR, the light source of the detection main body emits excitation light. The excitation light is applied to the reaction solution RS in the vessel lower portion 12 through the optical fiber 41 and the light guide 42 of the detection end portion 40 and the light transmitting part 22a of the cap 20. A fluorescent substance combined with the nucleic acids amplified in the reaction solution RS emits fluorescence by the applied excitation light. The fluorescence emitted from the fluorescent substance passes through the light transmitting part 22a of the cap 20, the light guide 42, and the optical fiber 41, and is detected by the light receiving element of the detection main body. The nucleic acids can be detected and/or quantitated by measuring intensity of the detected fluorescence.

### REFERENCE SIGNS LIST

100 PCR device
10 PCR vessel
11 Vessel upper portion
11a vessel upper protrusion
11b Vessel lower protrusion
12 Vessel lower portion
12a Vessel lowermost part
13 Elastic seal
20 Cap
21 Cap upper portion
22 Cap lower portion
22a Light transmitting part
30 Heater-cooler
31 Heat conductive block
31a Concave part
32 Peltier element
33 Heat exchange heatsink
40 Detection end portion
41 Optical fiber
42 Light guide
43 End-portion housing
50 Vessel supporter
51 Heater
RS Reaction solution

1. A PCR device comprising:
a vessel configured to house a reaction solution to be subjected to PCR;
a heater-cooler configured to heat and cool the reaction solution in the vessel;
a cap configured to seal the vessel; and
a detection end portion configured to detect a state of the reaction solution through the cap.

2. The PCR device according to claim 1, wherein
the vessel includes a vessel upper portion and a vessel lower portion protruding downward from the vessel upper portion, and the vessel lower portion is made smaller in diameter than the vessel upper portion,
the cap includes a cap upper portion and a cap lower portion protruding downward from the cap upper portion, and the cap lower portion is made smaller in diameter than the cap upper portion, and
in a state where the cap is mounted on the vessel, the cap upper portion is housed in the vessel upper portion, and the cap lower portion is housed in the vessel lower portion.

3. The PCR device according to claim 2, wherein the vessel upper portion includes a vessel upper protrusion on an inner surface, the cap upper portion includes a cap protrusion on an outer surface, and the cap is held to the vessel by engagement of the vessel upper protrusion and the cap protrusion.

4. The PCR device according to claim 2, further comprising an elastic seal configured to seal a gap between the vessel upper portion and the cap upper portion.

5. The PCR device according to claim 4, wherein the vessel upper portion includes a vessel lower protrusion on an inner surface, and the elastic seal is held to the vessel by engagement of the vessel lower protrusion and the elastic seal.

6. The PCR device according to claim 2, wherein, in the state where the cap is mounted on the vessel, a lower end of the detection end portion faces a light transmitting part provided on the cap lower portion.

7. The PCR device according to claim 6, wherein the light transmitting part faces a vessel lowermost part of the vessel lower portion.

8. The PCR device according to claim 7, wherein the vessel houses 3 μl to 10 μl of the reaction solution between the light transmitting part and the vessel lowermost part.

9. The PCR device according to claim 1, wherein the detection end portion includes an optical component, an end-portion housing configured to house a part of the optical component, and an end-portion protrusion protruding downward from the end-portion housing and configured to house a lower end part of the optical component.

10. The PCR device according to claim 2, wherein
the detection end portion includes an optical component, an end-portion housing configured to house a part of the optical component, and an end-portion protrusion protruding downward from the end-portion housing and configured to house a lower end part of the optical component, and
a lower part of the end-portion housing is housed in the cap upper portion, and the end-portion protrusion is housed in the cap lower portion.

11. The PCR device according to claim 9, wherein the optical component at least includes an optical fiber and a light guide provided at a lower end of the optical fiber.

12. The PCR device according to claim 11, wherein the light guide faces a light transmitting part provided on the cap lower portion.

13. The PCR device according to claim 1, further comprising a detection end portion moving mechanism configured to move the detection end portion in a horizontal direction and a perpendicular direction.

14. The PCR device according to claim 13, wherein the detection end portion is mounted with the cap.

15. The PCR device according to claim 2, wherein the heater-cooler includes a concave part configured to receive a part of the vessel lower portion.

16. The PCR device according to claim 15, wherein the heater-cooler includes a heat conductive block including the concave part, a Peltier element provided under the heat conductive block, and a heat exchange heatsink provided under the Peltier element.

17. The PCR device according to claim 16, wherein the heat conductive block includes a block protrusion protruding upward in a tapered shape, and the concave part is provided at an upper end of the block protrusion.

18. The PCR device according to claim 1, further comprising a heater configured to heat the vessel or the vessel lower portion.
